(19) United States
(12) Patent Application Publication
(10) Pub. No.: US 2007/0078645 A1
(43) Pub. Date: Apr. 5, 2007

(54) Filterbank-based processing of speech signals

(75) Inventors: Riitta Niemisto, Tampere (FI); Jukka Vartiainen, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/241,885

(22) Filed: Sep. 30, 2005

(51) Int. Cl. G10L 19/00

(52) U.S. Cl. 704/200.1

(57) ABSTRACT

A method for suppressing noise from a digital audio signal, the method comprising: obtaining the digital signal; dividing the digital audio signal into sub-bands of non-uniform frequency division essentially mitigate Bark scale, corresponding sub-band signals having downsampling ratios by which a frame rate of an audio encoder, expressed in a number of samples in each frame, is divisible; calculating coarse estimates of signal levels for the non-uniform sub-bands; calculating smoothed signal level estimates for the non-uniform sub-bands based on the coarse estimates; and combining the processed sub-band signals into a digital output signal.

### FIELD OF THE INVENTION

The present invention relates to signal processing, and more particularly to filterbank-based processing of speech signals.

### BACKGROUND OF THE INVENTION

In the field of speech signal processing, a traditional approach has suggested to carry out some speech enhancement tasks, particularly noise suppression, in frequency domain. Noise suppression systems are typically based on DFT (Discrete Fourier Transform) processing, which has generally been agreed to be well suited for noise suppression.

In a typical noise suppression system, as shown in FIG. 1, a noisy speech signal x[n] is first divided into a plurality (M) of frequency bands x₀[n], x₁[n], . . . , x_{M-1}[n], whereby a non-uniform frequency band division is typically used. A non-uniform structure has been claimed to be more natural than uniform because of human perception; this is often referred to with the Bark scale, which defines the first 24 critical (non-uniform) bands of human hearing. The signal levels are calculated on said frequency bands, which give a noisy speech spectrum of the signal. Then, background noise level of the frequency bands is estimated, resulting in a background noise spectrum. Based on the noise level and the signal level, gains g₀, g₁, . . . , g_{M-1} for noise suppression are computed, and the frequency bands are weighted by the rule y_{M}[n]=g_{M}×_{M}[n]. Finally, a full band speech signal y[n] is re-synthesized from the weighted frequency bands y₀[n], y₁[n], . . . , y_{M-1}[n]. In DFT-based signal processing, a non-uniform band division, which mitigates Bark scale has been typically realized by averaging neighbouring spectrum taps.

The above signal processing tasks are typically carried out as DFT/IDFT (Inverse DFT) processing, but it is apparent for a skilled person that also analysis/synthesis filterbanks can be used to carry out the same tasks as depicted in FIG. 1, even though the benefits of using filterbank-based processing in noise suppression are not so obvious. For example, in view of noise suppression a major problem in the field of filterbanks has been that it seems to be very difficult to design non-uniform filterbanks that mitigate Bark-scale with affordable cost for real-time applications.

However, in many devices wherein speech signal processing is required, such as in mobile phones and other telecommunication devices, at least some speech enhancement tasks, like acoustic echo control (AEC) and dynamic range control (DRC), would be preferable to carry out as filterbank-based processing. For example, a multiband DRC can be carried out either as DFT processing or as filterbank-based processing, but the latter one provides better voice quality. A further advantage of the filterbank-based processing is that it allows utilizing both time-domain signal processing methods and frequency-domain signal processing methods. Obviously, a common platform for all speech enhancement tasks would be beneficial. Since filterbanks provide a useful platform for versatile signal processing, there is naturally an incentive to transform also noise suppression into filterbank-based processing.

U.S. Pat. No. 6,377,637 discloses a method for filterbank-based noise suppression, wherein an estimation of signal levels in frequency-limited sub-bands is carried out using exponential smoothing. The processing in sub-bands is carried out sample by sample.

However, this prior art arrangement has the shortcoming that processing signals sample by sample, combined with exponential smoothing, is computationally quite complex and requires a great amount of processing power, which is a significant drawback especially in portable devices. Furthermore, since speech enhancement is followed (or preceded) by a speech coding, noise suppression processing must be synchronized with the speech codec to minimize the delay prior to transmission. U.S. Pat. No. 6,377,637 concentrates only on frequency bands produced by the filterbank, but it is silent about synchronization with the speech codec.

### SUMMARY OF THE INVENTION

Now there is invented an improved method and technical equipment implementing the method, by which an efficient noise suppression is achieved in a filterbank platform, while simultaneously providing synchronization with an audio encoder. Various aspects of the invention include a method, a noise suppression system, an electronic device, a computer program and a hardware module, which are characterized by what is stated in the independent claims. Various embodiments of the invention are disclosed in the dependent claims.

According to a first aspect, a method according to the invention is based on the idea of obtaining a digital audio signal; dividing the digital audio signal into sub-bands of non-uniform frequency division essentially mitigating Bark scale, corresponding sub-band signals having downsampling ratios by which a frame rate of an audio encoder, expressed in a number of samples in each frame, is divisible; calculating coarse estimates of signal levels for said non-uniform sub-bands; calculating smoothed signal level estimates for said non-uniform sub-bands based on the coarse estimates; and combining the processed sub-band signals into a digital output signal.

According to an embodiment, the method further comprises processing the sub-band signals frame by frame, wherein a length of a processing frame is selected such that a length of an audio frame of the audio encoder is divisible by the length of said processing frame.

According to an embodiment, said step of dividing the digital audio signal further comprises: dividing the digital audio signal into sub-band signals of uniform frequency division, said sub-band signals having downsampling ratios by which the frame rate of the audio encoder is divisible; and combining said uniform sub-band signals into non-uniform sub-bands that essentially mitigate Bark scale.

According to an embodiment, the coarse estimates of the signal levels for said non-uniform sub-bands is computed by averaging absolute values of samples over a frame and over corresponding sub-band signals.

According to an embodiment, said step of calculating the smoothed signal level estimates further comprises: calculating two smoothed signal level estimates of the signal level, the first estimate reflecting smoothly the changes in the signal level and the second estimate reflecting fast changes in the signal level; and indicating changes in the signal level by comparing the relative difference of said first and second estimates to a threshold value.

According to an embodiment, the method further comprises downsampling the sub-band signals by a downsampling ratio of 8 for a narrowband audio signal and by a downsampling ratio of 16 for a wideband audio signal.

According to an embodiment, the method further comprises dividing the digital signal into sub-band signals of non-uniform frequency division, whereby a downsampling ratio for lower frequencies of a spectrum is different than for upper frequencies of the spectrum. According to an embodiment, the number of the non-uniform sub-bands for a narrowband audio signal is at least 12 and for a wideband audio signal at least 16.

The arrangement according to the invention provides significant advantages. A major advantage of the filterbank-based processing with oversampled filterbanks is that sub-band signals in neighbouring bands can be attenuated or amplified by any factor without producing audible distortion, which property is also very beneficial for other speech enhancement tasks, like for dynamic range control (DRC). An advantage is that since the signal analysis is carried out as frame-based processing, it facilitates the synchronization of the filterbank-based noise suppression with the audio encoder and it is also computationally much more efficient than analysing signals sample by sample. Furthermore, downsampling of sub-band signals adds computational efficiency, particularly in acoustic echo control, compared to processing with non-decimated sub-band signals or to processing in time domain. A further advantage is that the analysis based on the non-uniform band division according to the invention uses a computationally more efficient post-processing of the signals than a uniformly divided filterbank, and also provides better audio quality.

According to a second aspect, there is provided a noise suppression system for suppressing noise from a digital audio speech signal, the system comprising: input means for obtaining a digital audio signal; band splitting means for dividing the digital audio signal into sub-bands of non-uniform frequency division essentially mitigating Bark scale, corresponding sub-band signals having downsampling ratios by which a frame rate of an audio encoder, expressed in a number of samples in each frame, is divisible; processor means for calculating coarse estimates of signal levels for said non-uniform sub-bands; processor means for calculating smoothed signal level estimates for said non-uniform sub-bands based on the coarse estimates; and recombining means for combining the processed sub-bands into a digital output signal.

The further aspects of the invention include various apparatuses arranged to carry out the inventive steps of the above method.

### BRIEF DESCRIPTION OF THE DRAWINGS

In the following, various embodiments of the invention will be described in more detail with reference to the appended drawings, in which

FIG. 1 shows a generalized noise suppression system according to prior art;

FIG. 2 shows an analysis-synthesis filterbank system according to an embodiment of the invention;

FIG. 3 illustrates some examples of the computation of the smoothed signal levels and background noise estimation in two sub-bands according to an embodiment of the invention;

FIG. 4 shows a flow chart of a noise suppression method according to an embodiment of the invention

FIG. 5 shows an example of filters in a non-uniform filterbank with two sections; and

FIG. 6 shows an electronic device according to an embodiment of the invention in a reduced block chart.

### DESCRIPTION OF EMBODIMENTS

In filterbank-based processing, sub-band signals are processed in lowered sampling rates. The filterbank is uniform if all the sub-band signals have the same bandwidth; otherwise it is non-uniform. Generally, uniform filterbanks have R₀=R₁=. . . =R_{M-1}≡R, wherein R is the downsampling ratio. If the sum of all sub-band bandwidths exceeds the bandwidth of the combined signal, i.e. the sum Σ(1/Rₘ)>1, wherein m=0, . . . , M−1, the filterbank is oversampled.

Oversampled filterbanks are known be best suited for filterbank-based processing, because the frequencies that are aliased in downsampling the sub-channel signals are below a threshold and sophisticated methods for alias compensation are advantageously not needed. Application of alias compensation to filterbank-based noise suppression, and more generally, to filterbank-based processing would be very difficult, because they are derived assuming that the signals do not change considerably in processing.

In the following, the embodiments relating to noise suppression are described in connection with uniform filterbanks for simplicity. The embodiments can also be applied in connection with non-uniform filterbanks. Although a non-uniform band division is not necessary for noise suppression, it may prove to be useful e.g. in high quality echo control, as is disclosed further below. Such non-uniform filterbank does not mitigate Bark-scale but averaging over subbands, similarly as in uniform case, can further refine the non-uniform band division.

Furthermore, for the sake of illustration the embodiments are described in connection with speech signals, but it is apparent for those skilled in the art that the embodiments are equally applicable to any audio signal. The operations of the embodiments are described in connection with speech codecs in general. A speech codec is a unit comprising the functionalities of both a speech encoder and a speech decoder. Even though a device arranged to perform speech encoding typically also includes means for performing speech decoding (i.e. the device comprises a codec), it is apparent for those skilled in the art that an encoder and a decoder can be implemented as standalone units. Accordingly, the embodiments can be carried out in connection with an audio encoder.

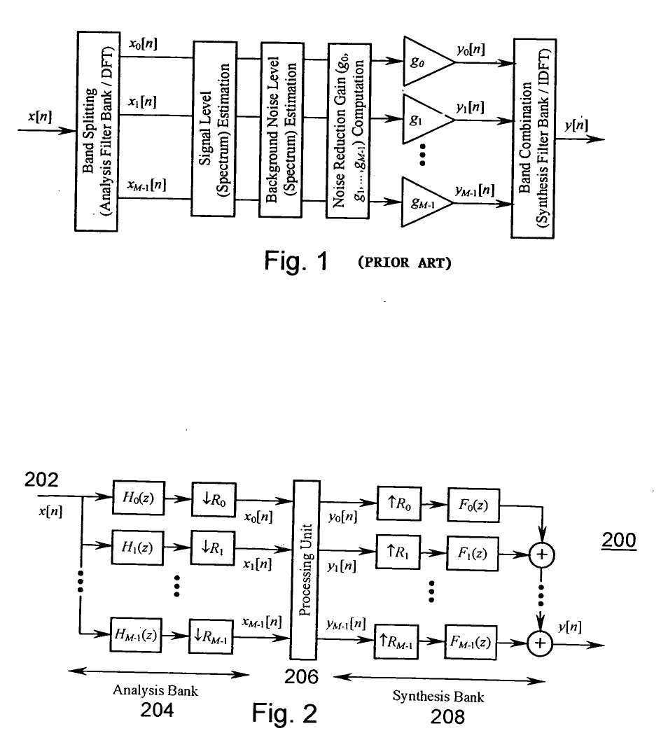

An embodiment of the invention is illustrated in FIG. 2. The system 200 according to the embodiment receives a digital speech signal x[n] including noise at the input 202. The noisy signal is first split into uniform sub-bands x₀[n], x₁[n], . . . , x_{M-1}[n] using an analysis filterbank 204 such that a frame rate of the speech codec, expressed in samples in each frame, is divisible by downsampling ratios in the said sub-bands. This advantageously facilitates synchronizing the filterbank-based noise suppression with the speech codec. In order to achieve a non-uniform frequency band division, these sub-bands are combined into suitable non-uniform bands that mitigate Bark scale in the processing unit 206. As mentioned above, the processing can also be carried out using non-uniform filterbanks, whereby the noisy signal is split directly into non-uniform band, and no combination of uniform sub-bands is required. However, using non-uniform filterbanks is, at least for the time being, computationally significantly heavier, and thus using uniform sub-bands is a more preferable implementation.

Then coarse estimates of signal levels are calculated on said non-uniform sub-bands, and based on the coarse estimates, the signal level estimates are computed such that the resulting estimate is smooth, but has fast transitions. Finally, a full band speech signal y[n] is combined from the weighted frequency bands y₀[n], y₁[n], . . . , y_{M-1}[n] in a synthesis filterbank 208.

Compared to conventional DFT-based processing of an audio signal, a significant advantage of the filterbank-based processing is that neighbouring bands can be attenuated or amplified by any factor without producing audible distortion. This facilitates noise suppression in difficult noise conditions, especially since the bands corresponding to lowest frequencies can be attenuated by any factor. This property is also very beneficial for multiband dynamic range control (DRC), especially in a case wherein several speech-processing tasks are implemented in a common platform as a pre-processor or a postprocessor to a speech codec.

According to an embodiment, the signal processing is carried out as frame-based processing, which is computationally much more efficient than processing sample by sample. In a typical speech codec used in mobile communication systems, such as an AMR (Adaptive Multi-Rate) codec, signals are processed with a 20 ms (or a 30 ms) frame rate. The frame rate, expressed in samples, has to be divisible by the downsampling ratio. Thus, in order to support both 20 ms and 30 ms frame rate, the downsampling ratio R has to divide 80 samples (AMR narrowband speech, 8 kHz sampling rate) or 160 samples (AMR wideband speech, 16 kHz sampling rate) per each 10 ms. According to an embodiment, the downsampling ratios are R=8 and R=16 for narrowband and wideband, respectively. Thus each sub-band has a 500 Hz bandwidth with 10 samples in each 10 ms frame. Downsampling of sub-band signals brings savings in computational complexity compared to processing with non-decimated sub-band signals.

The coarse estimate of the noisy speech level is used in noise suppression gain computation, as depicted in FIG. 1. According to an embodiment, the coarse estimate of signal level is computed by averaging absolute values of samples over a frame and over corresponding sub-band signals. The non-uniform sub-bands consist of several uniform bands, whereby the number of the non-uniform bands in narrowband case is preferably at least 12 and in wideband case is preferably at least 16, if an adequate audio quality is desired. If the number of the non-uniform bands is remarkably lower, the band division does not necessarily mitigate Bark scale any longer. However, such band division may become useful in such applications where the available processing power is rather low. Naturally, the audio quality with such band division is also degraded.

The analysis based on the non-uniform band division according to invention, i.e. non-uniform sub-bands consisting of several uniform bands, enables also computationally more efficient post-processing of the signals than uniformly divided filterbank, and provides also better audio quality.

According to an embodiment, when computing the signal level estimates in sub-bands, two smoothed estimates xₛ₁[t] and xₛ₂[t] of the signal level are updated according to the rule
xₛ[t]=αxₛ[t−1]+(1−α)xₘ[t] (1.)
wherein xₘ[t] refers to the coarse estimate and xₛ[t] refers to either of the smoothed estimates. The value for α (0<<α<1) is set high for xₛ₁[t] and relatively low for xₛ₂[t]. Thus, xₛ₁[t] is smooth while x_{S2}[t] follows fast changes in signal level better. Now the relative difference of xₛ₁[t] and xₛ₂[t] can be used to indicate changes in signal level, i.e. if the value of

$$\frac{{x}_{s 1} [ t ] - {x}_{s 2} [ t ]}{{x}_{s 1} [ t ]} \qquad ( 2. )$$

exceeds a given threshold, it indicates that there is a significant change in signal level. The value of xS₂[t] is used for changing the value of xₛ₁[t] fast. It can be set, for example, as follows:
xₛ₁[t]:=½(xₛ₁[t]+xₛ₂[t]) (3.)

However, if this would force the value of xₛ₁[t] below the current estimate of background noise level, then the value of xₛ₁[t] is set to the background noise level. This is to ensure that possible gaps in the signal that result from a missing frame caused e.g. by a microphone (noise suppression in uplink), or more likely by a transmission channel (noise suppression in downlink) do not force the background noise estimate suddenly to very low values. Naturally, the value of xₛ₁[t] can go below background noise level, if the signal level goes below it without an abrupt change.

In the previous example, the value for α=0.5. A skilled man appreciates that, depending on the nature of the signals, in certain occasions it would be more viable to use a value for a that deviates from 0.5. For example, if a value of α=0.7 would be used, the equation 3 would become:
xₛ₁[t]:=0.7xₛ₁[t]+0.3xₛ₂[t] (4.).

It is apparent that these values for a are just some examples, how the changes in signal level can be estimated, without limiting the actual implementation by any means.

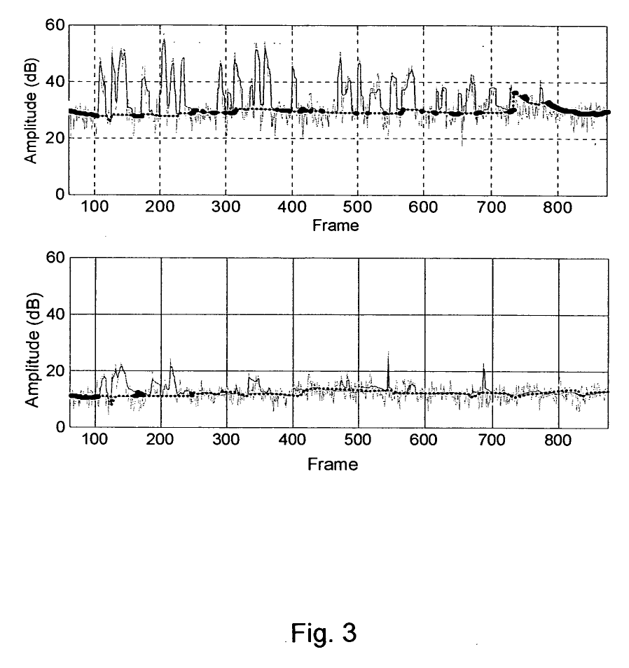

Accordingly, the estimate resulting from the above equations is smooth when the signal level does not change much, but transitions both up and down are rapid. FIG. 3 illustrates some examples of the computation of the smoothed signal level and background noise level estimation in two sub-bands, 500-1000 Hz (above) and 3000-3833 Hz (below). The examples disclose a speech period of about 800 speech frames, i.e. about 16 seconds. The dimmed curve refers to the coarse estimate of the signal level, the solid curve refers to the smoothed signal level and the dotted line to the estimated background noise level of a noisy speech sample. Thick black dots on the estimated background noise level curve denote such frames where background noise level estimate is updated.

Even though the above subbands are just arbitrary selected from the whole spectrum of the speech signal (i.e. consisting of all subbands), FIG. 3 illustrates the fact that the spectrum of the speech signal changes rapidly between phonemes, but is otherwise constant between frames. Noise spectrum changes slowly. There is quite a lot of variation in the coarse estimate (the dimmed line), but the background noise estimate does not respond to the random changes of the coarse estimate and remains smooth. Accordingly, it is obvious that smoothed spectrum is a more robust basis for background noise estimation and voice activity detection (VAD) than the coarse estimate, which has been obtained by averaging only.

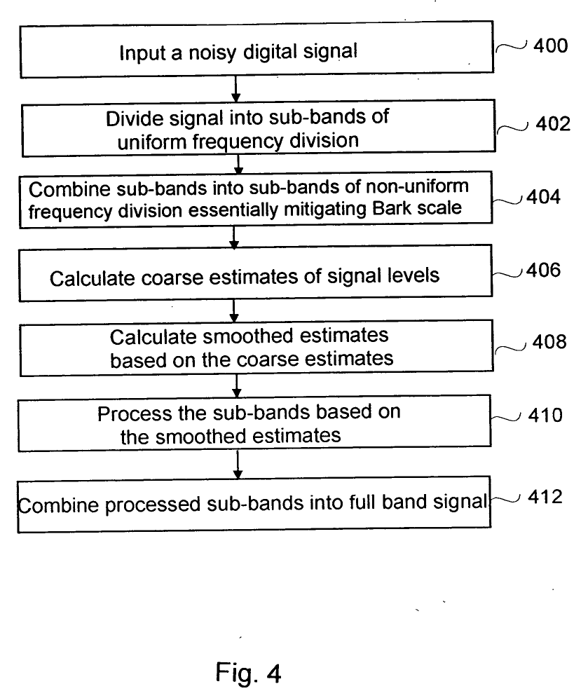

An example of the filterbank-based processing of speech signals according to some embodiments is depicted in the flow chart of FIG. 4. A digital signal including noise is first input (400) in the processing system, and the signal is split (402) into uniform sub-bands using an analysis filterbank. The sub-bands are downsampled such that the downsampling ratios divide the frame rate of the speech codec expressed in frames, thus facilitating the synchronization of the filterbank-based noise suppression with the speech codec. Then the uniform sub-bands of the digital signal are combined (404) into sub-bands of non-uniform frequency division essentially mitigating Bark scale. Then coarse estimates of signal levels are calculated (406) for the non-uniform sub-bands by averaging absolute values of samples over a speech frame and corresponding sub-band signals. Thereafter, smoothed spectrum estimates are calculated (408) for the non-uniform sub-bands based on the coarse estimates, and the smoothed spectrum estimates are used in the actual processing (410) of the uniform sub-band signals. The processing, as such, can be carried out according to any known method, typically including at least background noise estimation, gain calculation for noise suppression and weighting of sub-band signals, as explained above. Finally, the processed uniform sub-band signals are combined (412) into a full band digital output signal in a synthesis filterbank.

From the noise suppression point of view, it is indifferent how the signals are divided into frequency bands as long as frequency band division on low frequencies is sufficiently dense. Accordingly, by implementing the above-described noise suppression framework with a uniform filterbank, as described above, or with a non-uniform filterbank, wherein noise suppression is further refined to obtain a frequency band division that mitigates Bark scale, the same filterbank framework can advantageously be utilized for other speech enhancement tasks also.

An important speech enhancement task is the acoustic echo control (AEC). Echo appears in most communication channels, wherein it can be the outcome of impedance mismatches along a communication line. However, acoustic echoes due to leakage from the loudspeaker to the microphone in accessories like hands-free telephony devices are far more difficult to cancel. If a low quality acoustic echo control is used, during double talk, not just the echo, but also near-end speech tends to be attenuated. This may also happen during single talk, if background noise from far-end is strong and resembles speech. Consequently, there is a demand for a high quality acoustic echo control system.

There are three partly contradictory design requirements for filterbank design in high quality acoustic echo control and related speech enhancements. First, adaptive filtering can be carried out more efficiently the lower the sampling rates in sub-bands are. This suggests the use of uniform filterbanks, wherein the number of channels is as high as possible for a given delay and stopband attenuation is at minimum. Second, the stopband attenuation of the sub-band filters dictates cumulative alias in downsampling, which from the adaptive filtering point of view is noise. Thus, the higher the stopband attenuation, the better echo attenuation can be achieved until the level of background noise is reached. Third, in real-time applications, low delay is not only desirable but also required by standards.

Non-uniform filterbanks are more natural in sub-band speech processing because of human perception. Audio signal processing with orthogonal non-uniform filterbank implementation have been proposed e.g. by Z. Cvetkovic and J. D. Johnston: “Nonuniform Oversampled Filterbanks for Audio Signal Processing”, IEEE Trans. Speech Audio Proc., 11(5): 393-399, September 2003. However, the problem with the orthogonal non-uniform filterbank is that the delay of the filtering is equal to the order of the longest filter, causing typically an unsatisfactory long delay for real-time applications.

Now, according to an embodiment, the above-described filterbank framework is implemented as a biorthogonal non-uniform filterbank, wherein the delay can have arbitrary values. Such filterbank allows very low delay, which is a prerequisite for any real-time application, accordingly also for a high quality acoustic echo control system.

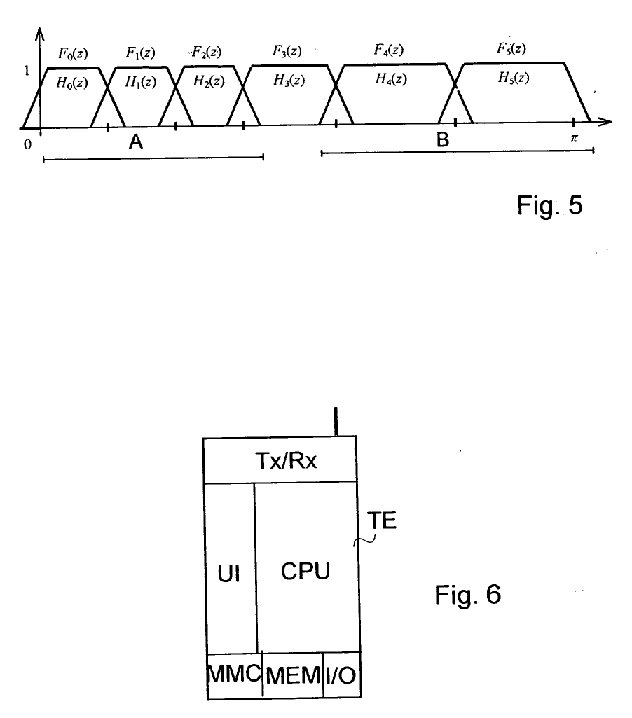

A low complexity non-uniform filterbank consists of sections of several uniform filterbanks. Consecutive sections are joined by transition filters between the sections. In a low complexity implementation, the number of sections, S, is usually set very small, typically 2 or 3. According to an embodiment, there are two uniform sections, one corresponding to 0-4 kHz, and the other one corresponding to 4-8 kHz, which sections are joined by a transition filter. The filters from the same section are obtained by a generalized DFT (GDFT) modulation from a single prototype; the frequency responses of the filters are shifted versions of the frequency response of the prototype. FIG. 5 shows an example of filters, which belong to a non-uniform filterbank with two sections, A and B. The first three filters, F₀(z), F₁(z) and F₂(z), belong to the section A, and the filters F₄(z) and F₅(z) belong to the section B, which sections are joined by the transition filter H₃(z).

It is desirable to have high frequency resolution in the low band because of human perception. Furthermore, a speech signal typically has a spectrum that has a low pass nature. Thus, strong low frequencies cumulate on weaker high frequencies in downsampling and high stopband attenuation is needed especially for the sub-band filters that correspond to high frequencies. Sufficient level of cumulative alias and delay can be obtained with non-uniform filterbanks, where the frequency resolution provided by the filterbank is higher in low than in high frequencies. This is illustrated in the example of FIG. 5 such that the section A corresponding to the lower frequencies includes three filters with mutually uniform frequency bands, and section B corresponding to the upper frequencies includes only two filters with mutually uniform frequency bands, but the frequency bands of filters in section A and in section B being, however, mutually non-uniform and providing advantageously higher frequency resolution in lower frequencies of the speech signal.

The design of the biorthogonal non-uniform filterbank according to an embodiment is further illustrated with the following equations. Let us denote Mₛ, s=0, . . . , S−1, as the number of channels of the uniform filterbank from which the filters in section s are extracted. Let mₛ be the number of filters in section s. Then the number of the channels of the non-uniform filterbank is given by

$$M = {\sum }_{s = 0}^{S - 1} {m}_{s} + S - 1. \qquad ( 5. )$$

The normalized width of channels in section s is dₛ=π/Mₛ, with π corresponding to 8 kHz in the case of wideband signals. Biorthogonal non-uniform filterbanks have the advantage over orthogonal non-uniform filterbanks that there is no condition on the width of the transition channels, whereas in orthogonal non-uniform filterbanks the width is strictly defined by the width of channels in neighbouring uniform sections.

Accordingly, by denoting \tilde{d}ₛ, s=0, . . . , S−1, as the normalized widths of the transition channels, it follows that

$$π {\sum }_{s = 0}^{S - 1} \frac{{m}_{s}}{{M}_{s}} + {\sum }_{s = 1}^{S} {\tilde{d}}_{s} = π \qquad ( 6. )$$

Let Aₛ(z), s=0, . . . , S−1, be the prototypes of the GDFT modulated uniform sections. Let D be the overall delay of the non-uniform filterbank. Then the impulse response of an analysis filter is
h_{k[n]=α}_{s[n]e}^{jπ(k+α}^{ₛ}^{) (n-D/2)/M}^{ₛ} (7.)
for some s∈0, . . . , S−1. The numbers αₛ are determined by the position of the first filter in the section. For the first section we have α₀ =½. Similar expressions hold for the synthesis filters, the prototypes being now Bₛ(z), s =0, . . . , S−1.

The design provides a platform for high quality acoustic echo control with low delay. Furthermore, since the non-uniform design consists of sections of uniform GDFT modulated filterbanks, the implementation is also computationally rather efficient.

FIG. 6 illustrates a simplified structure of a data processing device (TE), wherein the filterbank-based signalling processing system according to the invention can be implemented. The data processing device (TE) can be, for example, a mobile terminal, a PDA device or a personal computer (PC). The data processing unit (TE) comprises I/O means (I/O), a central processing unit (CPU) and memory (MEM). The memory (MEM) comprises a read-only memory ROM portion and a rewriteable portion, such as a random access memory RAM and FLASH memory. The information used to communicate with different external parties, e.g. a CD-ROM, other devices and the user, is transmitted through the I/O means (I/O) to/from the central processing unit (CPU). If the data processing device is implemented as a mobile station, it typically includes a transceiver Tx/Rx, which communicates with the wireless network, typically with a base transceiver station (BTS) through an antenna. User Interface (UI) equipment typically includes a display, a keypad, a microphone and a loudspeaker. The microphone and the loudspeaker can also be implemented as a separate hands-free unit. The data processing device may further comprise connecting means MMC, such as a standard form slot, for various hardware modules, which may provide various applications to be run in the data processing device.

The functionality of the invention may be implemented in a terminal device, such as a mobile station, most preferably as a computer program which, when executed in a central processing unit CPU, affects the terminal device to implement procedures of the invention. Functions of the computer program SW may be distributed to several separate program components communicating with one another. The computer software may be stored into any memory means, such as the hard disk of a PC or a CD-ROM disc, from where it can be loaded into the memory of mobile terminal. The computer software can also be loaded through a network, for instance using a TCP/IP protocol stack.

It is also possible to use hardware solutions or a combination of hardware and software solutions to implement the inventive means. Accordingly, the above computer program product can be at least partly implemented as a hardware solution, for example as ASIC or FPGA circuits, in a hardware module comprising connecting means for connecting the module to an electronic device and various means for performing said program code tasks, said means being implemented as hardware and/or software.

It is obvious that the present invention is not limited solely to the above-presented embodiments, but it can be modified within the scope of the appended claims.

What is claimed is:

1. A method for suppressing noise from a digital audio signal, the method comprising:
obtaining the digital audio signal;
dividing the digital audio signal into sub-bands of non-uniform frequency division essentially mitigating Bark scale, corresponding sub-band signals having downsampling ratios by which a frame rate of an audio encoder, expressed in a number of samples in each frame, is divisible;
calculating coarse estimates of signal levels for said non-uniform sub-bands;
calculating smoothed signal level estimates for said non-uniform sub-bands based on the coarse estimates; and
combining the processed sub-band signals into a digital output signal.

2. The method according to claim 1, the method further comprising:
processing the sub-band signals frame by frame, wherein a length of a processing frame is selected such that a length of an audio frame of the audio encoder is divisible by the length of said processing frame.

3. The method according to claim 1, wherein said step of dividing the digital audio signal further comprises:
dividing the digital audio signal into sub-band signals of uniform frequency division, said sub-band signals having sampling rates by which the frame rate of the audio encoder is divisible; and
combining said uniform sub-band signals into non-uniform sub-bands that essentially mitigate Bark scale.

4. The method according to claim 1, wherein
the coarse estimates of the signal levels for said non-uniform sub-bands is computed by averaging absolute values of samples over a frame and over corresponding sub-band signals.

5. The method according to claim 1, wherein said step of calculating the smoothed signal level estimates further comprises:
calculating two smoothed signal level estimates of the signal level, the first estimate reflecting smoothly the changes in the signal level and the second estimate reflecting fast changes in the signal level; and
indicating changes in the signal level by comparing the relative difference of said first and second estimates to a threshold value.

6. The method according to claim 1, the method further comprising:
downsampling the sub-band signals by a downsampling ratio of 8 for a narrowband audio signal and by a downsampling ratio of 16 for a wideband audio signal.

7. The method according to claim 1, the method further comprising:
dividing the digital signal into sub-band signals of non-uniform frequency division, whereby a downsampling ratio for lower frequencies of a spectrum is different than for upper frequencies of the spectrum.

8. The method according to claim 1, wherein
the number of the non-uniform sub-bands for a narrowband audio signal is at least 12 and for a wideband audio signal at least 16.

9. A noise suppression system for suppressing noise from a digital audio signal, the system comprising:
input means for obtaining the digital audio signal;
band splitting means for dividing the digital audio signal into sub-bands of non-uniform frequency division essentially mitigating Bark scale, corresponding sub-band signals having downsampling ratios by which a frame rate of an audio encoder, expressed in a number of samples in each frame, is divisible;
processor means for calculating coarse estimates of signal levels for said non-uniform sub-bands;
processor means for calculating smoothed signal level estimates for said non-uniform sub-bands based on the coarse estimates; and
recombining means for combining the processed sub-band signals into a digital output signal.

10. The system according to claim 9, wherein
the sub-bands are processed frame by frame, a length of a processing frame being selected such that a length of an audio frame of the audio encoder is divisible by the length of said processing frame.

11. The system according to claim 9, wherein said band splitting means are arranged to:
divide the digital audio signal into sub-bands of uniform frequency division, said sub-band signals having sampling rates by which the frame rate of the audio encoder is divisible; and
combine said uniform sub-band signals into non-uniform sub-bands that essentially mitigate Bark scale.

12. The system according to claim 9, wherein
said processor means are arranged to compute the coarse estimates of signal levels for said non-uniform sub-bands by averaging absolute values of samples over a frame and over corresponding sub-band signals.

13. The system according to claim 9, wherein said processor means are arranged to:
calculate two smoothed signal level estimates of the signal level, the first estimate reflecting smoothly the changes in the signal level and the second estimate reflecting fast changes in the signal level; and
indicate changes in the signal level by comparing the relative difference of said first and second estimates to a threshold value.

14. The system according to claim 9, wherein
said band splitting means are arranged to downsample the sub-band signals by a downsampling ratio of 8 for a narrowband audio signal and by a downsampling ratio of 16 for a wideband audio signal.

15. The system according to claim 9, wherein
said band splitting means are arranged to divide the digital signal into sub-bands of non-uniform frequency division, whereby a downsampling ratio for lower frequencies of a spectrum is different than for upper frequencies of the spectrum.

16. The system according to claim 9, wherein
the number of the non-uniform sub-bands for a narrowband audio signal is at least 12 and for a wideband audio signal at least 16.

17. The system according to claim 9, wherein
smoothed spectrum estimates are used as a basis for background noise estimation and voice activity detection.

18. The system according to claim 9, wherein said means comprise an analysis filterbank, a processing unit and a synthesis filterbank.

19. The system according to claim 18, wherein
said filterbanks are biorthogonal non-uniform filterbanks; and
said filterbanks are arranged to implement a low-delay acoustic echo control processing of a digital audio signal.

20. The system according to claim 19, wherein
said biorthogonal non-uniform filterbank consists of at least two sections, wherein
frequency division of filters within each section is uniform; and
the frequency division of filters is higher in a section covering lower frequencies of an audio signal than in a section covering higher frequencies of an audio signal.

21. A computer program product, stored on a computer readable medium and executable in a data processing device, for suppressing noise from a digital audio signal, the computer program product comprising:
a computer program code section for obtaining the digital audio signal;
a computer program code section for dividing the digital audio signal into sub-bands of non-uniform frequency division essentially mitigating Bark scale, corresponding sub-band signals having downsampling ratios by which a frame rate of an audio encoder, expressed in a number of samples in each frame, is divisible;
a computer program code section for calculating coarse estimates of signal levels for said non-uniform sub-bands;
a computer program code section for calculating smoothed signal level estimates for said non-uniform sub-bands based on the coarse estimates; and
a computer program code section for combining the processed sub-band signals into a digital output signal.

22. A detachable hardware module for suppressing noise from a digital audio signal, the module comprising:
connecting means for connecting the module to an electronic device;
means for obtaining the digital audio signal;
means for dividing the digital audio signal into sub-bands of non-uniform frequency division essentially mitigating Bark scale, corresponding sub-band signals having downsampling ratios by which a frame rate of an audio encoder, expressed in a number of samples in each frame, is divisible;
means for calculating coarse estimates of signal levels for said non-uniform sub-bands;
means for calculating smoothed signal level estimates for said non-uniform sub-bands based on the coarse estimates; and
means for combining the processed sub-band signals into a digital output signal.

23. An electronic device configured to carry out noise suppression for a digital audio speech signal, the device comprising:
input means for obtaining the digital audio signal;
band splitting means for dividing the digital audio signal into sub-bands of non-uniform frequency division essentially mitigating Bark scale, corresponding sub-band signals having downsampling ratios by which a frame rate of an audio encoder, expressed in a number of samples in each frame, is divisible;
processor means for calculating coarse estimates of signal levels for said non-uniform sub-bands;
processor means for calculating smoothed signal level estimates for said non-uniform sub-bands based on the coarse estimates; and
recombining means for combining the processed sub-band signals into a digital output signal.

24. The electronic device according to claim 23, comprising
connecting means for connecting a detachable hardware module, said hardware module including the means for carrying out the noise suppression for a digital audio signal.

25. The electronic device according to claim 23, wherein said audio encoder is a speech encoder and said audio signal is a speech signal.
